(19) United States
(12) Patent Application Publication
(10) Pub. No.: US 2006/0112899 A1
(43) Pub. Date: Jun. 1, 2006

(54) Wipe for pets' paws

(76) Inventor: Heather D. Zur, Brunswick, ME (US)

Correspondence Address: NILS PETER MICKELSON, 228 WATERMAN ROAD, BUXTON, ME, 04093-3718, US

(21) Appl. No.: 10/991,576

(22) Filed: Nov. 18, 2004

(51) Int. Cl. A01K 29/00

(52) U.S. Cl. 119/652

(57) ABSTRACT

A wipe used specifically for cleaning a pet's paws safely and thoroughly, said wipe being environmentally disposable and its cleansing components comprising a solution of white vinegar and water.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

This invention is related to the pet care industry, specifically to cleaning a pet's paws safely and thoroughly. The invention was thought of while cleaning a dog's paws as the dog came into the house after being outside. It seemed reasonable that a disposable wipe made with white vinegar and water would safely clean the germs off of a dog's paws, and would not harm the dog if she licked her paws. This invention is more convenient and more effective than cleaning a pet's paws with a dry towel or with just water in that this invention is naturally disinfecting and convenient.

White vinegar and water are not harmful to pets and will not harm the pets if they lick their paws. The wipes will also prevent the pets from spreading germs in a person's house, car, etc.

### BRIEF SUMMARY OF THE INVENTION

The Invention is a naturally disinfecting, disposable wipe used to clean a pet's paws. It can be used to clean the paws of dogs, cats, ferrets, and other pets. The cleansing solution on the wipe is primarily based upon vinegar, which has natural germ-killing properties. White vinegar is preferred because it does not harm the pet. An approximate proportion of the ingredients is 80 percent vinegar mixed with 20 percent water.

### BRIEF DESCRIPTION OF THE SEVERAL VIEWS OF THE DRAWINGS

FIG. 1 is a perspective view of the moistened wipe as described in the specification.

FIG. 2 is a perspective view of the container as described in the invention.

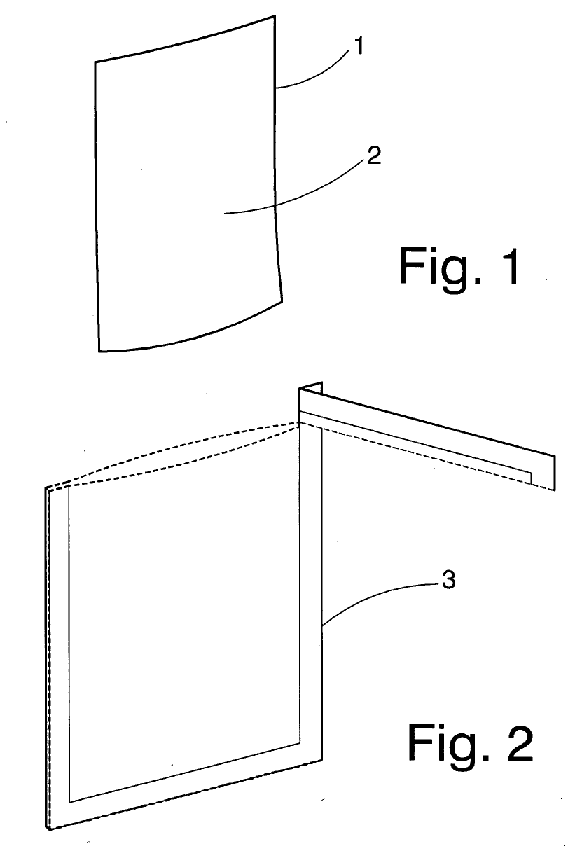

### DETAILED DESCRIPTION OF THE INVENTION

The invention is a naturally disinfecting, disposable wipe used to clean a pet's paws. The wipe contains a cleaning solution of white vinegar and water.

This invention differs from other wipes on the market because it contains only natural ingredients (white vinegar and water) which will clean a pet's paws, while not harming the pet. Although there is another wipe for pet's paws on the market, that wipe does not contain the ingredients of white vinegar and water. To make my invention, a wipe (1) is moistened with a cleansing solution (2), and then packaged and sealed in a sealed container (3), such as an envelope or dispenser box which both prevents the solution (2) from evaporating and maintains said wipe (1) in a clean and sterile condition. When a pet's paws need cleaning, the pet owner opens the sealed container (3), removes the moist wipe (1), cleans the pet's paws, and discards the used wipe (1).

Because disposal has environmental implications, the solution (2) and wipe (1) should be environmentally friendly, biodegradable and benign to a pet's health. While many chemical solutions meet these requirements, my testing and experience shows the best results are obtained by using a solution of white vinegar and water, preferably in the proportions of approximately 70-85 percent white vinegar and 15-30 percent water. Best results are obtained when these percentages lie between 75-85 percent white vinegar and 15-25 percent water.

Because many functionally similar variations can be envisioned, the scope of my invention should be determined by the appended claims, rather than by the specific embodiments recited above.

What I claim as my invention is:

1. A wipe for cleaning a pet's paws, said wipe moistened with a cleansing solution comprised of water and vinegar.

2. The wipe of claim 1 wherein said cleansing solution is comprised of water and white vinegar.

3. The wipe of claim 2 wherein said cleansing solution comprises water and white vinegar mixed in proportions ranging between 15 percent and 25 percent water with 75 percent and 85 percent white vinegar.

4. The wipe of claim 1 packaged in a sealed container, whereby said sealed container keeps said wipe moist and sterile until needed for use.

5. The method of making the wipe of claim 4 comprising the steps of
a) moistening said wipe with said cleansing solution and
b) packaging said wipe in said sealed container,
whereby said sealed container keeps said wipe moist and sterile until needed for use.
